(19) United States
(12) Patent Application Publication
(10) Pub. No.: US 2016/0206975 A1
(43) Pub. Date: Jul. 21, 2016

(54) NON-BARRIER CHAMBERED PRESSURIZED RESERVOIR

(71) Applicant: Parker-Hannifin Corporation, Cleveland, OH (US)

(72) Inventor: Blake Adam Carl, University Heights, OH (US)

(21) Appl. No.: 15/001,761

(22) Filed: Jan. 20, 2016

Related U.S. Application Data
(60) Provisional application No. 62/105,484, filed on Jan. 20, 2015.

(51) Int. Cl. B01D 19/00

(52) U.S. Cl. CPC B01D 19/0042

(57) ABSTRACT

A horizontal non-barrier pressure vessel including a first chamber and a second chamber that are separated by a divider. The first chamber includes a first end proximal an opening, a second end distal the opening, and an uppermost surface that extends horizontally along the length of the first chamber or is inclined upwardly from the first end to the second end. The second chamber operatively adjoins the first chamber at the second end opposite the opening. A flow passage extends across the divider and enables fluid communication with the first chamber at an upper region of the second end and with the second chamber at a lower region. The divider may include vertically oriented bottom and top baffles being spaced to form the flow passage. The pressure vessel may include a plurality of segments and/or chambers sequentially arranged along a horizontal course.

### RELATED APPLICATIONS

This application claims the benefit of U.S. Provisional Application No. 62/105,484 filed Jan. 20, 2015, which is hereby incorporated herein by reference in its entirety.

### FIELD OF INVENTION

The present invention relates generally to pressure vessels for hydraulic systems, and more particularly to non-barrier pressure reservoirs.

### BACKGROUND

Pressurized vessels are used in hydraulic systems as reservoirs for the hydraulic working fluid. The pressurized reservoir not only acts as a source for storing hydraulic fluid, but can also act as a degassing system to allow trapped gas to escape from the hydraulic fluid. Therefore, pressurized reservoirs of this type are commonly used in the hydraulic systems of vehicles, such as hydraulic hybrid vehicles, because the degassing of the hydraulic fluid reduces cavitation in the hydraulic system pumps.

Two types of pressurized reservoirs are generally known. A typical non-barrier-type reservoir includes a pressurized vessel that stores the hydraulic working fluid in a lower region of the reservoir that has a fluid inlet/outlet located near or at the bottom of the reservoir. A head space in the upper region of the reservoir allows trapped gas to escape through a gas-fluid boundary. A problem with these typical non-barrier reservoirs is that the gas-fluid boundary can shift in the reservoir, for example when used on a vehicle that accelerates or changes slope, which may cause the gas-fluid boundary to reach the reservoir outlet, allowing gas to reenter the hydraulic system. In order to prevent the gas-fluid boundary from reaching the inlet/outlet, typical non-barrier-type reservoirs are configured vertically and are filled with a large volume of unused hydraulic fluid (i.e., dead volume) above the inlet/outlet. A disadvantage of typical non-barrier reservoirs includes packaging constraints due to their vertical orientation, as well as the additional cost associated with transporting an otherwise unnecessary dead volume of hydraulic fluid.

A second type of pressurized reservoir is a barrier-type reservoir. In contrast to the above-referenced non-barrier-type reservoir, the barrier-type reservoir does not provide a head space for allowing trapped gas to escape from the hydraulic system, and therefore does not have a gas-fluid boundary where the gas and hydraulic fluid interact. Instead, the barrier-type reservoir includes a piston or bladder that acts against the hydraulic working fluid when charging or discharging the fluid through the reservoir's inlet/outlet. Since the barrier-type reservoir does not have a gas-fluid boundary, there is minimal concern over trapped gas reentering the hydraulic system through the outlet when, for instance, the vehicle accelerates or changes slope. As such, the barrier-type reservoir can be mounted horizontally for more efficient packaging, and also requires a smaller dead volume of hydraulic fluid. However, a disadvantage of the barrier-type reservoir is that it does not provide a means for trapped gases to naturally escape from the working fluid through a gas-fluid boundary, and therefore requires a separate degassing system for removal of the trapped gas.

### SUMMARY OF INVENTION

The present invention provides a pressurized vessel that uses a gas-fluid boundary for enabling trapped gas to naturally escape the hydraulic working fluid, but which can be mounted horizontally for efficient packaging, and/or that uses less dead volume of hydraulic fluid while preventing the gas-fluid boundary from reaching the outlet of the reservoir.

According to an aspect of the invention, a non-barrier pressure vessel includes an opening for enabling flow of hydraulic fluid into or out of the pressure vessel, a first chamber having a first end proximal said opening and a second end distal said opening, and a second chamber operatively adjoining the first chamber at the second end of the first chamber opposite the opening.

The first chamber has an uppermost surface that extends horizontally along the length of the first chamber or is inclined upwardly from the first end to the second end of the first chamber.

A divider separates the first chamber from the second chamber, and a flow passage is provided across the divider for enabling hydraulic fluid and/or gas to flow between an upper region of the first chamber to a lower region of the second chamber, wherein the flow passage communicates with the upper region at the second end of the first chamber and the lower region of the second chamber.

Embodiments of the invention may include one or more of the following additional features separately or in combination.

For example, the flow passage may communicate with the second end of the first chamber at a level no less than the lowest level of the uppermost surface of the first chamber.

The flow passage may have a cross-sectional area no greater than twice the cross-sectional area of the opening for enabling hydraulic fluid and/or gas to escape the first chamber and move through the flow passage in response to hydraulic fluid entering the first chamber, and for enabling hydraulic fluid to flow into the first chamber in response to the first chamber being discharged of hydraulic fluid.

The divider may include vertically oriented top and bottom baffles, and the flow passage may include spacing, gaps and/or channels that are located above, between, through and/or below the respective baffles.

Any number of additional top and bottom baffles may separate additional chambers, and any number of additional chambers may be provided, all of the foregoing capable of having various sizes and configurations depending on the requirements of the hydraulic system in which the non-barrier pressure vessel is to be employed.

According to another aspect of the invention, a horizontal non-barrier pressure vessel is provided that includes an opening for enabling flow of hydraulic fluid into or out of the pressure vessel, a first chamber located proximal the opening, and a second chamber operatively adjoining the first chamber and being located distal the opening.

A bottom baffle and a top baffle separate the first chamber and second chamber of the exemplary pressure vessel, wherein the bottom baffle extends upwardly from a bottom portion of the pressure vessel and terminates at a top edge that is spaced from a top interior surface of the pressure vessel, defining a top gap; and the top baffle extends downwardly from a top portion of the pressure vessel and terminates at a bottom edge that is spaced from a bottom interior surface of the pressure vessel, defining a bottom gap.

The bottom edge of the top baffle is arranged at a level below the top edge of the bottom baffle. The bottom baffle is positioned proximal the first chamber and the top baffle is positioned distal the first chamber, wherein the top baffle and bottom baffle are spaced apart for forming a baffle channel therebetween.

Embodiments of the invention may include one or more of the following additional features separately or in combination.

For example, the first chamber of the non-barrier pressure vessel may include a top interior surface having a major portion and a minor portion, with the minor portion being arranged at a level above the major portion and located proximal the top edge of the bottom baffle.

The top edge of the bottom baffle may be arranged at the same level or at a level above the major portion, and is spaced from the respective major and minor portions for enabling gas in the first chamber to escape into the second chamber in response to hydraulic fluid entering the first chamber.

In some embodiments, the top interior surface minor portion may be configured as an upward step, and/or the top interior surface may be configured as an inclined plane.

According to another aspect of the invention a non-barrier pressure vessel includes a plurality of segments sequentially arranged from a first end portion to a second end portion along a horizontal course. The plurality of segments comprise a first segment that includes the first end portion, and at least one additional segment, wherein the at least one additional segment comprises a portion of an upstream chamber, a portion of a downstream chamber operatively adjoining the upstream chamber, and a bottom and top baffle separating the upstream chamber from the downstream chamber.

The bottom baffle extends upwardly from a bottom portion of the pressure vessel and terminates at a top edge that is spaced from a top interior surface of the pressure vessel, and the top baffle extends downwardly from a top portion of the pressure vessel and terminates at a bottom edge that is spaced from a bottom interior surface of the pressure vessel. The bottom edge of the top baffle is arranged at a level below the top edge of the bottom baffle. The bottom baffle is positioned proximal the upstream chamber and the top baffle is positioned distal the upstream chamber, wherein the top baffle and bottom baffle are spaced apart for forming a baffle channel therebetween.

In some embodiments, the layout or course of the pressure vessel can progress in a generally straight direction, or it can have bends, curves, forks, or any combination thereof.

The size of respective chambers and/or segments may be the same along the course, or the size may vary.

Segments and/or chambers of the exemplary pressure vessel may be integrally formed with one another, or the pressure vessel may be modularly formed by connecting respective segments and/or chambers with fasteners, threads, lips, flanges, welds, or other similar connecting means.

Yet another aspect of the invention includes a method for degassing a hydraulic fluid for use in a hydraulic system, the method including the steps: (i) allowing hydraulic fluid having trapped gases to enter the non-barrier pressure vessel through the opening; (ii) causing the hydraulic fluid having trapped gases to enter the first chamber; (iii) causing the trapped gases to move through the space above the top edge of the bottom baffle, then through the baffle channel, and then through the space below the bottom edge of the top baffle; (iv) causing the hydraulic fluid having trapped gases to enter the second chamber; and (v) causing the trapped gases to escape the working fluid through a gas-fluid boundary located in a chamber downstream from the first chamber.

The exemplary method may further include the steps: (i) allowing degassed hydraulic fluid to discharge from the non-barrier pressure vessel through the opening; (ii) causing the degassed hydraulic fluid to exit the first chamber; (iii) causing degassed hydraulic fluid from the second chamber to flow through the space below the bottom edge of the top baffle, then through the baffle gap, and then through the space above the top edge of the bottom baffle; and (iv) causing degassed hydraulic fluid to enter the first chamber for replenishing the degassed hydraulic fluid that has exited the first chamber.

In some embodiments, the first chamber of the non-barrier pressure vessel remains filled with hydraulic fluid and is devoid of a gas-fluid boundary for limiting the gas-fluid boundary from reaching the inlet/outlet, or opening.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1A is a cross-sectional side view of an exemplary non-barrier pressure vessel according to the invention;

FIG. 1B is a close-up of a portion of FIG. 1A;

FIG. 1C is a cross-sectional view of a bottom baffle taken along the line A-A of FIG. 1B;

FIG. 1D is a cross-sectional view of a top baffle taken along the line B-B of FIG. 1B;

FIG. 2 is a top plan view of another non-barrier pressure vessel according to the invention;

FIG. 3 is a cross-sectional side view of yet another non-barrier pressure vessel according to the invention;

FIG. 4 is a cross-sectional side view of a non-barrier pressure vessel according to still another aspect of the invention;

FIG. 5 is a cross-sectional side view of a further non-barrier pressure vessel according to the invention;

FIG. 6 is a cross-sectional side view of another non-barrier pressure vessel according to the invention;

FIG. 7 is a cross-sectional side view of still another non-barrier pressure vessel according to the invention;

FIGS. 8A-8F show a method for filling and emptying the non-barrier pressure vessel of FIG. 1A;

FIG. 9A shows the pressure vessel of FIG. 1A in a preferred full state; and

FIG. 9B shows the pressure vessel of FIG. 1A in a preferred empty state.

### DETAILED DESCRIPTION

The principles of the present invention have particular application to non-barrier pressure reservoirs, also referred to as gas-over-fluid reservoirs, and thus will be described below chiefly in this context. For example, a non-barrier pressure vessel according to certain aspects of the invention may be useful on vehicle systems, such as land vehicle systems, including hydraulic hybrid vehicles that utilize a hydraulic system requiring a pressurized hydraulic fluid reservoir. Accordingly, the hydraulic fluid utilized in such exemplary systems is commonly based on oil, water, or other liquids; and the gas utilized in such systems may be nitrogen, air, or a combination of gases. It will of course be appreciated, and also understood, that principles of this invention may be applicable to other gas-over-fluid systems where it is desirable to allow trapped gas to naturally escape the fluid, while restricting the gas-fluid boundary from reaching the inlet/outlet.

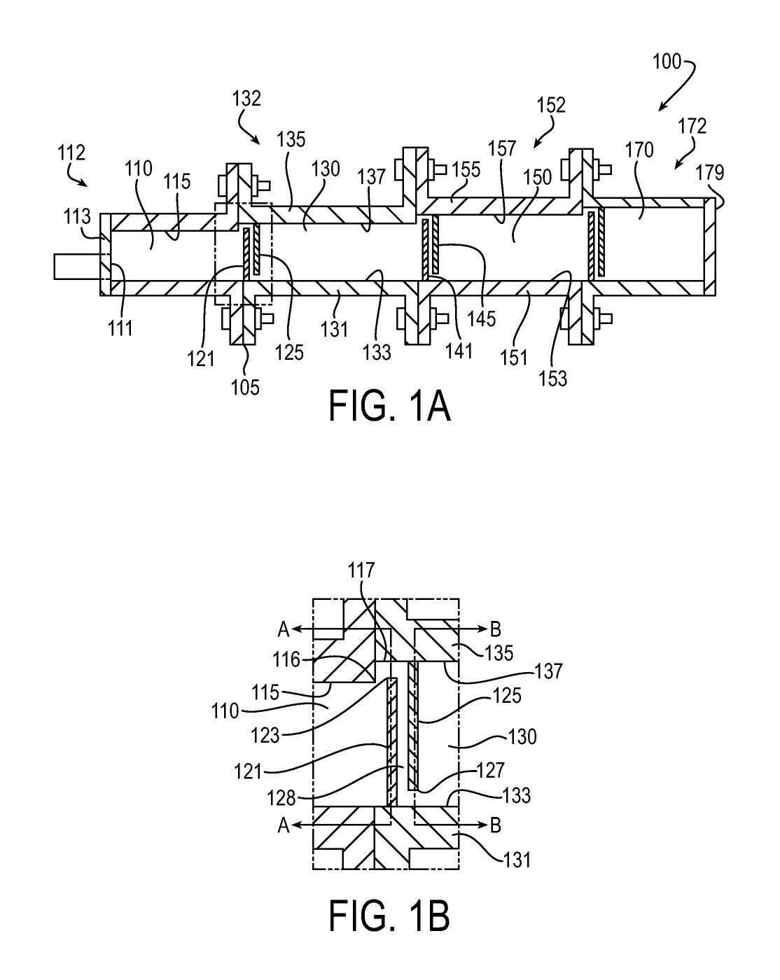

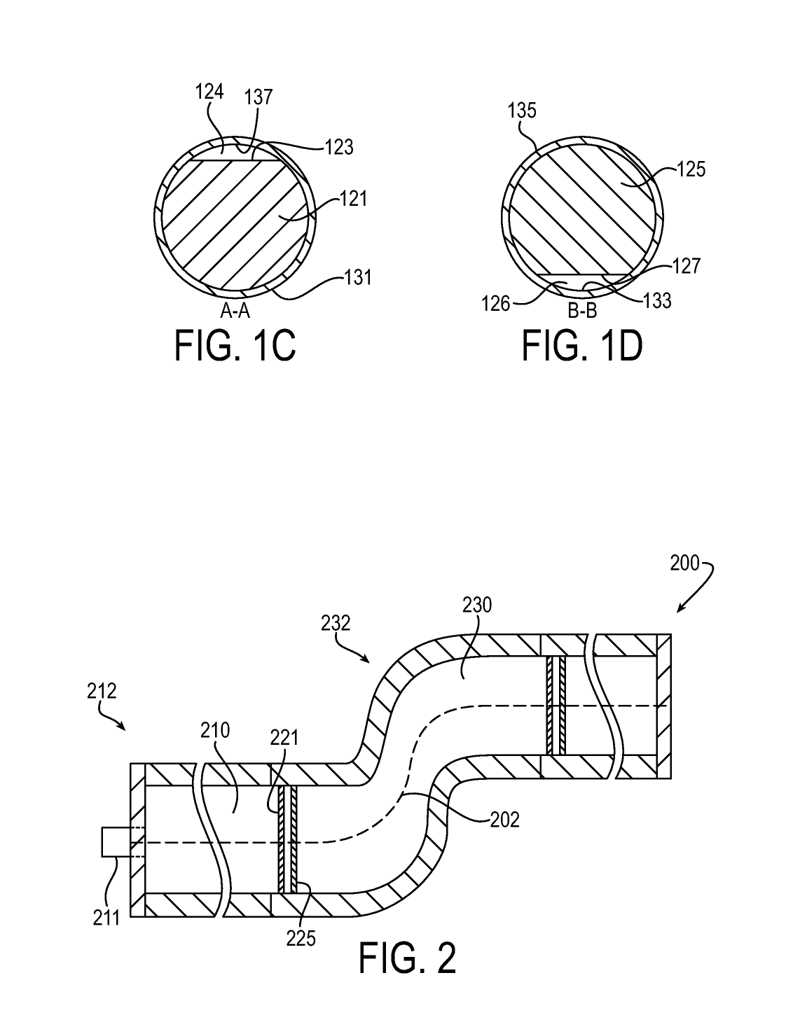

In the discussion above and to follow, the terms “upper”, “lower”, “top”, “bottom,” “end,” “inner,” “left,” “right,” “level,” “above,” “below,” “horizontal,” “vertical,” etc. refer to the non-barrier pressure vessel as viewed in a horizontal position, as shown in FIG. 1A. This is done realizing that these units, such as when used on vehicles, can be mounted on the top, bottom, or sides of other components, or can be inclined with respect to the vehicle chassis, or can be provided in various other positions. Furthermore, the terms “upstream” and “downstream” refer to the arrangement of components along a horizontal course as fluid flows into the pressure vessel through an opening, as viewed in FIG. 1A, realizing that hydraulic fluid may flow in either direction, i.e. into and out of the pressure vessel.

According to a general aspect of the invention, a horizontal non-barrier pressure vessel (hereinafter pressure vessel, or reservoir) is provided including a first chamber and a second chamber that are separated by a divider. The first chamber includes a first end proximal an opening, a second end distal the opening, and an uppermost surface that extends horizontally along the length of the first chamber or is inclined upwardly from the first end to the second end. The second chamber operatively adjoins the first chamber at the second end opposite the opening. A flow passage extends across the divider and enables fluid communication with the first chamber at an upper region of the second end and with the second chamber at a lower region. As hydraulic fluid having trapped gas enters the first chamber, the gas is forced through the flow passage into the second chamber. As degassed hydraulic fluid exits the first chamber, degassed fluid from the second chamber is forced through the flow passage to replenish the first chamber. The divider may include vertically oriented bottom and top baffles being spaced to form the flow passage. The pressure vessel may include a plurality of segments and/or chambers sequentially arranged along a horizontal course.

Turning now to FIG. 1A, an exemplary horizontal non-barrier pressure vessel 100 is shown. Pressure vessel 100 includes a top portion 135, a bottom portion 131, a first end portion 113, a second end portion 179, and an interior portion defined by the interior surfaces of the pressure vessel walls. The interior portion of pressure vessel 100 includes a first chamber 110, and a second chamber 130 that operatively adjoins first chamber 110, such that hydraulic fluid and/or gas may have relatively open fluid communication and/or flow between respective chambers. A bottom baffle 121 and a top baffle 125 separate first chamber 110 from second chamber 130.

As shown in FIG. 1A, first chamber 110 is bounded by interior surfaces of the pressure vessel walls, including the first end portion 113 that has an opening 111 for enabling flow of hydraulic fluid (hereinafter hydraulic fluid, fluid, or working fluid) into or out of pressure vessel 100. As such, first chamber 110 may be considered the first upstream chamber for receiving hydraulic fluid having trapped gases. However, it is envisioned that additional chambers, vessels, or connections may be made prior to first chamber 110 depending on the hydraulic system requirements, provided that the hydraulic fluid enters first chamber 110 upstream from bottom baffle 121, top baffle 125, and second chamber 130.

With reference to FIGS. 1A-1D, bottom baffle 121 is shown as being positioned proximal first chamber 110 and upstream from top baffle 125. Bottom baffle 121 extends upwardly from the bottom portion 131 of pressure vessel 100, and terminates at a top edge 123 that is spaced from a top interior surface 137 of the pressure vessel 100. As shown in FIGS. 1C-1D, the first chamber 110 and second chamber 130 are depicted as being cylindrically-shaped with circular cross-sections, and bottom baffle 121 is shaped as a flat disc that forms a sealing engagement with the interior surfaces of the pressure vessel walls, except for a top gap 124 that is formed by the space between the bottom baffle top edge 123 and pressure vessel top interior surface 137.

Top baffle 125 is shown as being positioned distal first chamber 110 and downstream from bottom baffle 121. Top baffle 125 extends downwardly from the top portion 135 of pressure vessel 100, and terminates at a bottom edge 127 that is spaced from a bottom interior surface 133 of the pressure vessel 100. As with bottom baffle 121, the top baffle 125 may also be shaped as a flat disc, forming a sealing engagement with the interior surfaces of the pressure vessel walls, except for a bottom gap 126 that is formed by the space between the top baffle bottom edge 127 and pressure vessel bottom interior surface 133.

Top baffle 125 is horizontally spaced from bottom baffle 121 and forms a baffle channel 128 therebetween. In addition, the bottom edge 127 of top baffle 125 is arranged at a level below the level of the top edge 123 of bottom baffle 121. In this configuration, shown in FIGS. 1A-1D, fluid having trapped gas is capable of entering first chamber 110 and filling first chamber 110 up to the level of the top edge 123 of bottom baffle 121. As the first chamber 110 is filled with hydraulic fluid, gas from the first chamber 110 is forced through top gap 124, baffle channel 128, and bottom gap 126, then into adjoining second chamber 130. Furthermore, as the fluid level in first chamber 110 rises above top edge 123, the fluid will flow through top gap 124, baffle channel 128, and bottom gap 126, then into adjoining second chamber 130. In this manner, the level of hydraulic fluid and/or gas in each chamber may be determined by the level of the respective edges of bottom and top baffles.

An aspect of the invention is to enable gas to escape from first chamber 110 and into downstream chambers, such as second chamber 130, in response to hydraulic fluid entering first chamber 110; and also to enable hydraulic fluid to flow from downstream chambers, such as second chamber 130, into first chamber 110 in response to hydraulic fluid being discharged from first chamber 110. The flow passage may enable such communication of hydraulic fluid and/or gas between an upper region at a second end of first chamber 110 and a lower region of second chamber 130. As such, it should be understood that the top gap 124, baffle channel 128, and bottom gap 126 may define the flow passage across the divider, and may be so dimensioned for enabling such fluid flow.

The flow passage may be sufficiently small for preventing or reducing a “waterfall effect” in which the hydraulic fluid “spills over” the flow passage and does not sweep away the gas trapped in an uppermost area of the flow passage. In other words, the maximum cross-sectional area of the flow passage, preferably the maximum cross-sectional area proximal the top gap 124, may be sized to restrict the fluid flow to a degree in which the hydraulic fluid entering the flow passage will build up and preferably contact the uppermost area of the flow passage to sweep away the trapped gas.

In certain embodiments, the flow passage may have a maximum cross-sectional area, preferably a maximum cross-sectional area proximal the top gap 124, no greater than twice the cross-sectional area of opening 111, and more preferably no greater than 1.5 times the cross-sectional area of opening 111, for reducing the “waterfall effect” between chambers.

The flow passage may also be sufficiently large for reducing an undesirable degree of fluid flow restriction between chambers. For example, where the opening 111 is suitably sized for providing a desired maximum flow rate through the pressure vessel 100, the flow passage may have a minimum cross-sectional area no less than half the cross-sectional area of opening 111, or no less than the cross-sectional area of opening 111, or no less than 1.5 times the cross-sectional area of opening 111.

It should be understood that the flow passage may be sized both sufficiently small for reducing the waterfall effect and sufficiently large for reducing an undesirable degree of fluid flow restriction. It should also be understood that the flow passage may have a constant cross-sectional area, or the cross-sectional area of the flow passage may vary. Additional features and objects according to aspects of the invention will be better understood in the description to follow.

According to an aspect of the invention, the pressure vessel may have the flow passage communicating with the second end of the first chamber at a level no less than the lowest level of an uppermost surface of the first chamber. Turning to FIGS. 1A-1D, a preferred but non-limiting embodiment according to this aspect is shown. As depicted in FIGS. 1C-1D, a top interior surface or uppermost surface of first chamber 110 includes a major portion 115 and a minor portion 117, wherein top interior surface minor portion 117 is arranged at a level above top interior surface major portion 115. In this embodiment, major portion 115 transitions with minor portion 117 at a transition area 116, and is configured as an upward step. The top interior surface minor portion 117 is located proximal bottom baffle top edge 123, and bottom baffle top edge 123 is horizontally spaced from the terminus of top interior surface major portion 115, or transition area 116, and is also vertically spaced from top interior surface minor portion 117. As shown in FIGS. 1A-1D, bottom baffle top edge 123 is arranged at the same level or at a level above top interior surface major portion 115, which enables hydraulic fluid to completely fill the major portion of first chamber 110, thereby forcing gas into second chamber 130 and eliminating a gas-fluid boundary from first chamber 110. Accordingly, the exemplary pressure vessel enables several advantages, such as reducing the likelihood of a gas-fluid boundary reaching the fluid inlet/outlet, or opening, while also providing for a gas-fluid boundary in downstream chambers that enables gas to naturally escape the hydraulic fluid without the need for a separate deaeration system. As such, the non-barrier pressure vessel according to this embodiment enables the pressure vessel to be mounted horizontally for efficient packaging, and also provides a minimal dead volume of fluid in the pressure vessel, such as an amount needed to completely fill the first chamber.

Although the pressure vessel of FIGS. 1A-1D shows top interior surface minor portion 117 configured as an upward step, an advantage according to this embodiment could also be achieved by providing progressively elevated top interior surfaces between major portions and minor portions, and/or between upstream and downstream chambers. For example, as described in other embodiments below, the pressure vessel top interior surface may be configured as an inclined plane. In addition, although FIGS. 1A-1D show top baffle 125 and bottom baffle 121 terminating at bottom edge 127 and top edge 123, respectively, it is also envisioned that baffles could have apertures or cutouts located at their respective bottom and top portions for achieving the same result, in which case respective bottom and top baffle edges would be considered the surfaces where fluid flows under or over respective baffles. Moreover, although the pressure vessel of FIGS. 1A-1D shows generally flat baffles being arranged substantially perpendicular to the interior surfaces of the walls, and being substantially parallel to one another, it is envisioned that baffles could include other configurations. For example, baffles could have tapers or varying cross-sectional thicknesses, and could be arranged at inclines with respect to the interior surfaces of the walls and/or inclined with respect to each other. The divider could even be a solid wall having internal flow passages, or a flow tube could be provided through the divider, or over the divider. Further, although FIGS. 1A-1D depict cylindrical chambers and corresponding round baffles, it should be understood that chambers and corresponding baffles could be other shapes, such as polygonal or ellipsoid. Also, it should be understood that the baffles can be arranged in the pressure vessel in any manner, such as inserted into sides of the pressure vessel, inserted as cylinder sleeves, fastened internally, welded, formed integrally, removably or irremovably attached, or attached in any other manner.

Turning again to FIG. 1A, pressure vessel 100 includes second chamber 130, which is arranged as a downstream chamber being located distal first end 113 and opening 111. Pressure vessel 100 also includes a third chamber 150 and a fourth chamber 170. It should be understood according to aspects of the invention that pressure vessel 100 may include a plurality of operatively adjoining chambers, such as two, three, four, five, or more chambers. In this manner, third chamber 150 may be considered an at least one additional chamber, with multiple additional chambers also being possible. It should also become apparent that second chamber 130 operates as an upstream chamber to third chamber 150, which is downstream from second chamber 130, but is also upstream from fourth chamber 170, and so on.

Also shown in FIG. 1A, a second bottom baffle 141 and a second top baffle 145 separate second chamber 130 and third chamber 150. In this embodiment, the second bottom baffle 141 and second top baffle 145 are configured in a similar manner as bottom baffle 121 and top baffle 125, respectively. As such, second bottom baffle 141 extends upwardly from a pressure vessel bottom portion 151 and terminates at a second bottom baffle top edge (not referenced) that is spaced from a pressure vessel top interior surface 157. Second top baffle 145 extends downwardly from a pressure vessel top portion 155 and terminates at a second top baffle bottom edge (not referenced) that is spaced from a pressure vessel bottom interior surface 153. As with bottom baffle 121 and top baffle 125, the top edge of second bottom baffle 141 is arranged at a level above the level of the bottom edge of second top baffle 145. Second bottom baffle 141 is positioned proximal second chamber 130, and second top baffle 145 is spaced downstream from second bottom baffle 141 for forming a second baffle channel therebetween.

It should be understood from the foregoing aspects that a bottom baffle and a top baffle corresponding to bottom baffle 121 and top baffle 125 may be provided for separating any upstream chamber from an operatively adjoining downstream chamber. It should also be understood that any upstream chamber may have a top interior surface with a major portion and minor portion configured in a corresponding manner as first chamber major portion 115 and minor portion 117, such that the corresponding minor portion may be arranged at a level above the corresponding major portion, such as an upward step, and may also have the top edge of the corresponding bottom baffle being arranged at the same level or at a level above the level of the corresponding top interior surface major portion. However, it is also envisioned that the transition between operatively adjoining chambers and/or corresponding bottom and top baffles need not be identical from chamber to chamber. For example, the first upstream chamber may have a top interior surface configured as an upward step with the bottom baffle top edge arranged at a level above the major portion, the next chamber downstream may have a top interior surface configured as an inclined plane, and the following downstream chamber may have a top interior surface that is level and devoid of steps, inclines, or other transitions.

Still referring to FIG. 1A, pressure vessel 100 is also shown as including a plurality of segments 112, 132, 152 and 172, sequentially arranged from first end portion 113 to second end portion 179 along a horizontal course (described in further detail below). The plurality of segments comprise a first segment 112 that includes first end portion 113 having opening 111. At least one additional segment is also provided, such as a second segment 132, a third segment 152, a fourth segment 172, and so on. As shown, second segment 132 includes bottom baffle 121 and top baffle 125, the configuration of which is described above.

As referenced above, the bottom baffle 121 and top baffle 125 may be considered to separate first chamber 110 from second chamber 130, and therefore the upstream flat surface of bottom baffle 121 may be considered to define a portion of first chamber 110, and the downstream flat surface of top baffle 125 may be considered to define a portion of second chamber 130. Accordingly, since second segment 132 may include bottom baffle 121 and top baffle 125, the second segment 132 may also be considered to include a portion of first chamber 110 and a portion of second chamber 130. Also as shown in FIG. 1A, the interior surface of the segment has an internal cross-sectional area that defines a cross-sectional area of a chamber major portion, for instance, a cross-section at the major portion 115. In FIG. 1A, each segment 112, 132, 152 and 172 of pressure vessel 100 is shown as having an internal cross-sectional area that is progressively larger for each downstream segment, which enables the respective top interior minor portions to be arranged at a level above the corresponding major portions, while maintaining a bottom interior surface that is at the same level between respective segments.

The pressure vessel segments 112, 132, 152, 172 allow pressure vessel 100 to be manufactured in a modular form, which may provide several advantages, including allowing for various lengths and sizes, allowing for various layouts or courses, and reducing manufacturing costs. As shown in FIG. 1A, the segments are connected by a flange and fastener 105, but other attachment means are also envisioned, such as welds, threads, and various other couplings, or various other connecting means, some of which are shown in other embodiments below. Although FIG. 1A shows bottom baffle 121 and top baffle 125 being arranged in second segment 132, it should also be appreciated that the bottom and top baffles could be included in the first segment, or multiple sets of baffles could be provided in a single segment, or a segment of the pressure vessel may have no baffles at all, depending on the hydraulic system needs and required layout of the pressure vessel. It should be understood that although FIG. 1A shows pressure vessel 100 having a plurality of segments, that the pressure vessel 100 may also be integrally formed as a unitary construction, such as a casting.

Turning now to FIGS. 2-7, other exemplary embodiments of a horizontal non-barrier pressure vessel are shown. The pressure vessels shown in FIGS. 2-7 are substantially similar to the above-referenced pressure vessel 100, and consequently the same reference numerals but indexed by 100 are used to denote structures corresponding to similar structures in the pressure vessel. In addition, the foregoing description of pressure vessel 100 is equally applicable to the pressure vessels in FIGS. 2-7, except as noted below. Moreover, it will be appreciated upon reading and understanding the specification that aspects of the pressure vessels may be substituted for one another or used in conjunction with one another where applicable.

Turning to FIG. 2, a top plan view of another horizontal non-barrier pressure vessel 200 is shown. Pressure vessel 200 includes a first chamber 210, and a second chamber 230 operatively adjoining first chamber 210. A bottom baffle 221 and a top baffle 225 separate first chamber 210 from second chamber 230, and bottom baffle 221 and top baffle 225 may be configured in a similar manner as corresponding bottom baffle 121 and top baffle 125, described above. It should also be understood that first chamber 210 may have a top interior surface with a major portion and minor portion configured in a corresponding manner as first chamber major portion 115 and minor portion 117, and the top edge of bottom baffle 221 may be arranged at the same level or a level above the level of the corresponding top interior surface major portion.

Pressure vessel 200 is also shown as having a first segment 212 and a second segment 232. The first segment 212 includes an opening 211 for allowing hydraulic fluid to enter or exit pressure vessel 200. The second segment 232 includes the bottom baffle 221, the top baffle 225, a portion of first chamber 210, and a portion of second chamber 230. Second segment 232 is sequentially arranged downstream from first segment 212 and defines a pressure vessel course 202. As shown in FIG. 2, the pressure vessel course 202 is configured as an s-shape. However, it is within the scope of this embodiment to provide a pressure vessel course progressing in any direction, such as straight, bent, curved, forked, chicaned, sinuous, or any combination thereof. In this manner, the pressure vessel course 202 may provide an additional advantage for pressure vessel 200 to be employed in complex and/or confined areas, such as being mounted horizontally on a vehicle chassis and navigating around mufflers and/or various other vehicle components. It should also be understood that pressure vessel 200 may include a plurality of segments, any of which may vary the direction of pressure vessel course 202. In addition, although the pressure vessel course 202 is defined above by the sequential progression of respective segments, it is also envisioned that sequential chambers could define the pressure vessel course where, for example, segments are not used.

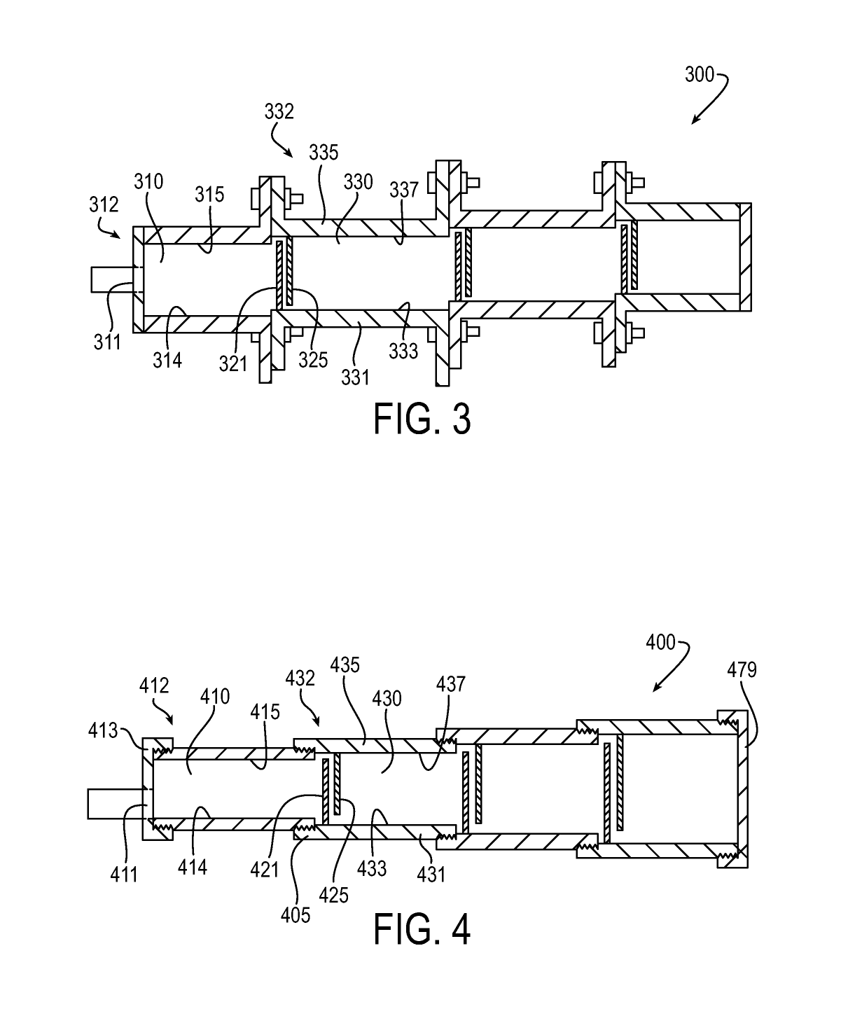

Turning now to FIG. 3, another horizontal non-barrier pressure vessel 300 is shown. Pressure vessel 300 includes an opening 311, a first chamber 310, a second chamber 330, a bottom baffle 321, a top baffle 325, a first segment 312, and a second segment 332. Pressure vessel 300 is similar to pressure vessel 100, except that first segment 312 and second segment 332 are arranged in an offset configuration, such that each of the segments and/or chamber major portions have the same internal cross-sectional area along the pressure vessel course. In this manner, the offset configuration of pressure vessel 300 provides for an upward step in the first chamber top interior surface major portion 315, similar to pressure vessel 100. However, unlike pressure vessel 100, a bottom interior surface 314 of the first segment 312 is also upwardly stepped in the transition to second chamber 332. An advantage of the offset configuration is that respective segments may be substantially the same, which may reduce manufacturing and inventory costs for assembling pressure vessel 300.

FIG. 4 shows yet another horizontal non-barrier pressure vessel 400. Pressure vessel 400 includes an opening 411, a first chamber 410, a second chamber 430, a bottom baffle 421, and a top baffle 425. As shown, pressure vessel 400 also includes a first segment 412 and a second segment 432 that are connected by threads 405. In this manner, the internal cross-sectional area of each segment progressively increases downstream, and the chamber major portions formed by respective segments are substantially coaxial with one another. The threaded configuration of the embodiment according to FIG. 4 may have advantages for ease of assembly of pressure vessel 400.

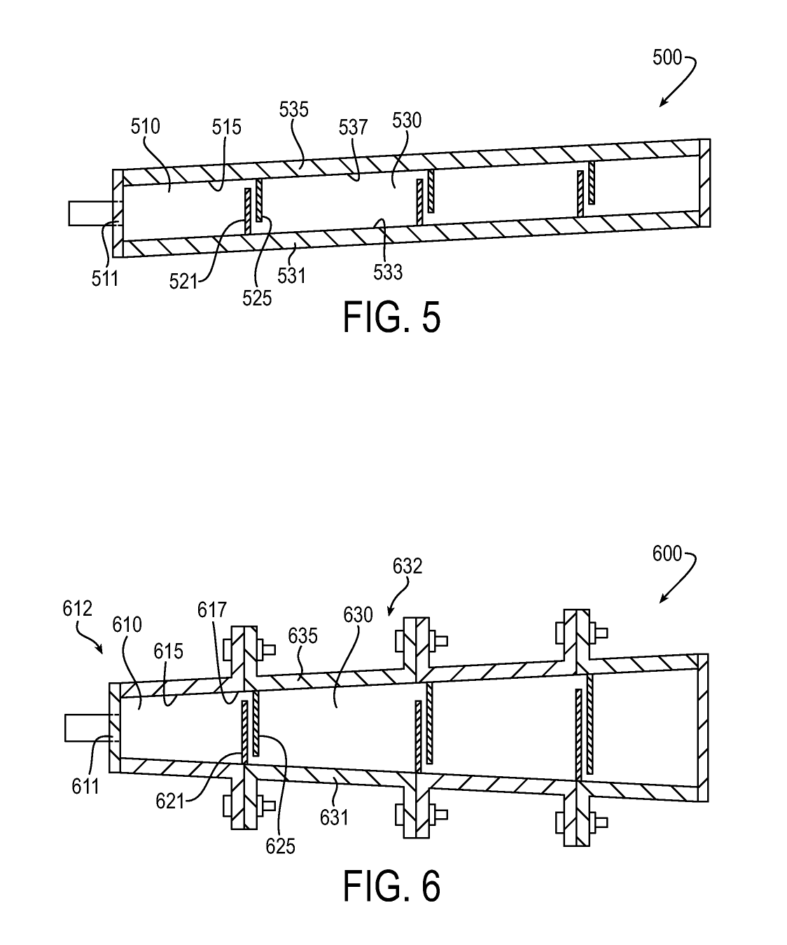

FIG. 5 depicts a horizontal non-barrier pressure vessel 500 according to another embodiment of the invention. Pressure vessel 500 includes an opening 511, a first chamber 510, a second chamber 530, a bottom baffle 521, and a top baffle 525. As shown, pressure vessel 500 is integrally formed and is not segmented; however, pressure vessel 500 could be segmented. The top interior surface 537 of pressure vessel 500 is upwardly inclined in the horizontal or downstream direction for enabling gas in first chamber 510 to escape into second chamber 530 in response to hydraulic fluid entering pressure vessel 500. In this manner, a top interior surface major portion 515 is also upwardly inclined, and may transition with a top interior surface minor portion (not shown) that is proximal the top edge of bottom baffle 521. As shown in FIG. 5, the transition between major portion 515 and the minor portion could be a smooth transition, such that the minor portion is defined by the continuum of the inclined plane defining major portion 515. However, it is also envisioned that the upward incline of the minor portion could increase at the transition area. Although the bottom interior surface 533 of pressure vessel 500 is also shown as being upwardly inclined, it is also envisioned that bottom interior surface could be provided at the same level for each chamber.

Turning now to FIG. 6, yet another non-barrier pressure vessel 600 is shown. Pressure vessel 600 includes an opening 611, a first chamber 610, a second chamber 630, a bottom baffle 621, and a top baffle 625. As shown, pressure vessel 600 also includes a first segment 612 and a second segment 632 that are frustum shaped, and have corresponding chamber major portions being frustum shaped. As with pressure vessel 500 of FIG. 5, the pressure vessel 600 of FIG. 6 has a top interior surface major portion 615 that is formed as an upwardly inclined plane, which may smoothly transition with a top interior surface minor portion (not shown) that is defined by the continuum of the inclined plane that defines major portion 615.

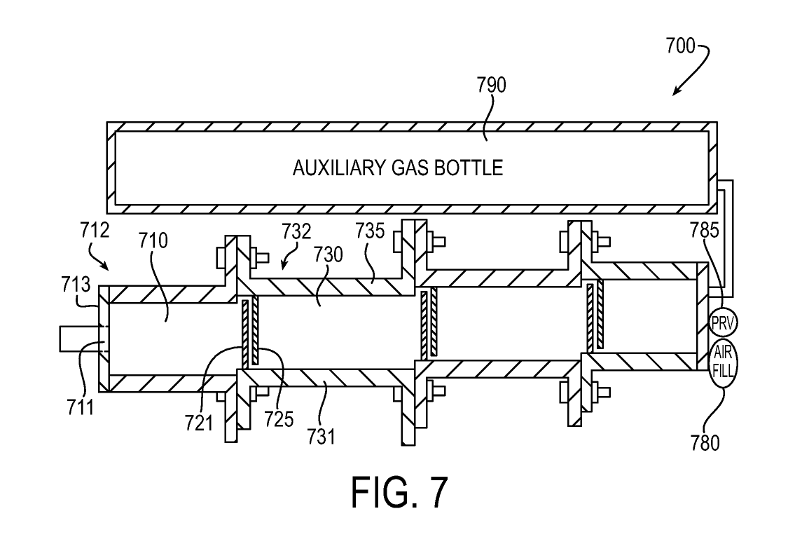

FIG. 7 shows a non-barrier pressure vessel 700 that is similar to pressure vessel 300 of FIG. 3, but which also includes an external gas vessel 790. The external gas vessel 790 is provided for enabling a greater amount of pre-charged gas, which effectively increases the gas volume of the pressure vessel 300. As the ratio of gas volume to hydraulic fluid volume in the pressure vessel 300 may affect the pressure level in the pressure vessel 300, the external gas vessel 790 may enable less pressure fluctuation (i.e. pressure leveling) as the volume of hydraulic fluid in pressure vessel 300 increases or decreases. As shown, external gas vessel 790 may preferably be connected to the last downstream chamber, but could also be operatively connected to any downstream chamber from a first chamber 710, such as a second chamber 730, or could be connected to multiple chambers.

The pressure vessel 700 may also include a gas port 780 for connecting to a source of compressed gas for pressurizing the pressure vessel 700.

Pressure vessel 700 may preferably be pressurized to a low pressure level of about 500 psi or less; or about 300 psi or less; or about 200 psi or less.

The pressure vessel 700 may also include a pressure relief valve 785 for releasing pressurized gas, for example, if the hydraulic fluid becomes hot, thereby causing gas in the pressure vessel to expand and increase the pressure in the pressure vessel. The pressure relief valve 785 may be operatively connected to pressure vessel 700 at similar locations as the gas port 780. It should be understood that external gas vessel 790, gas port 780, and pressure relief valve 785 may be provided with any embodiment according to the present invention, including those depicted in FIGS. 1-6.

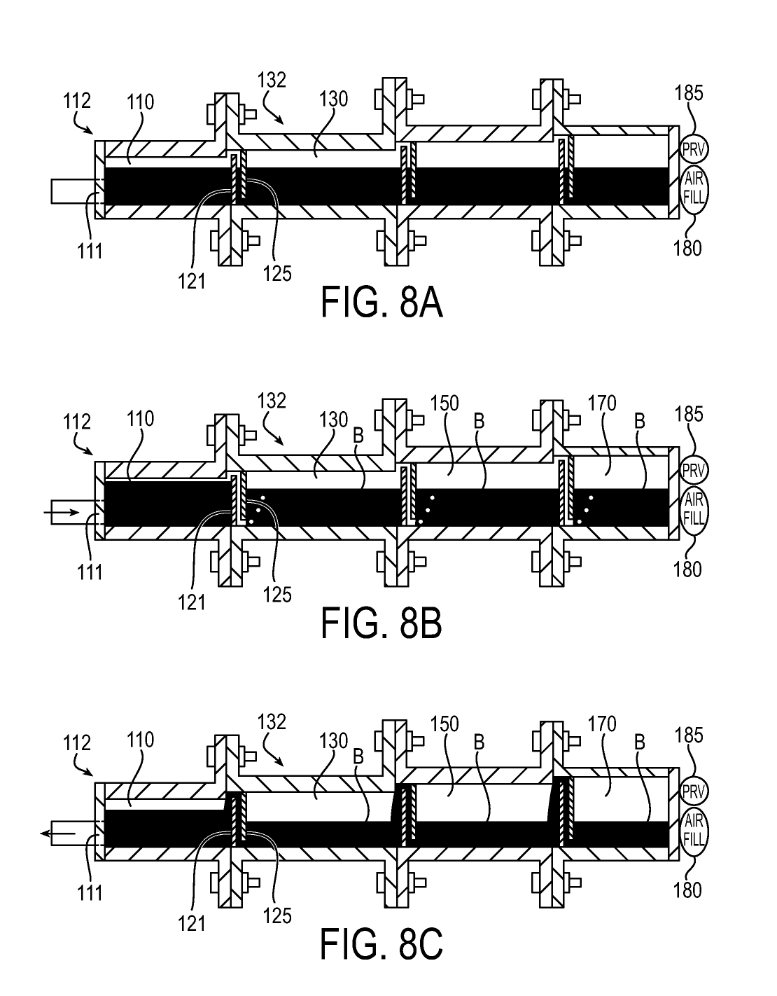

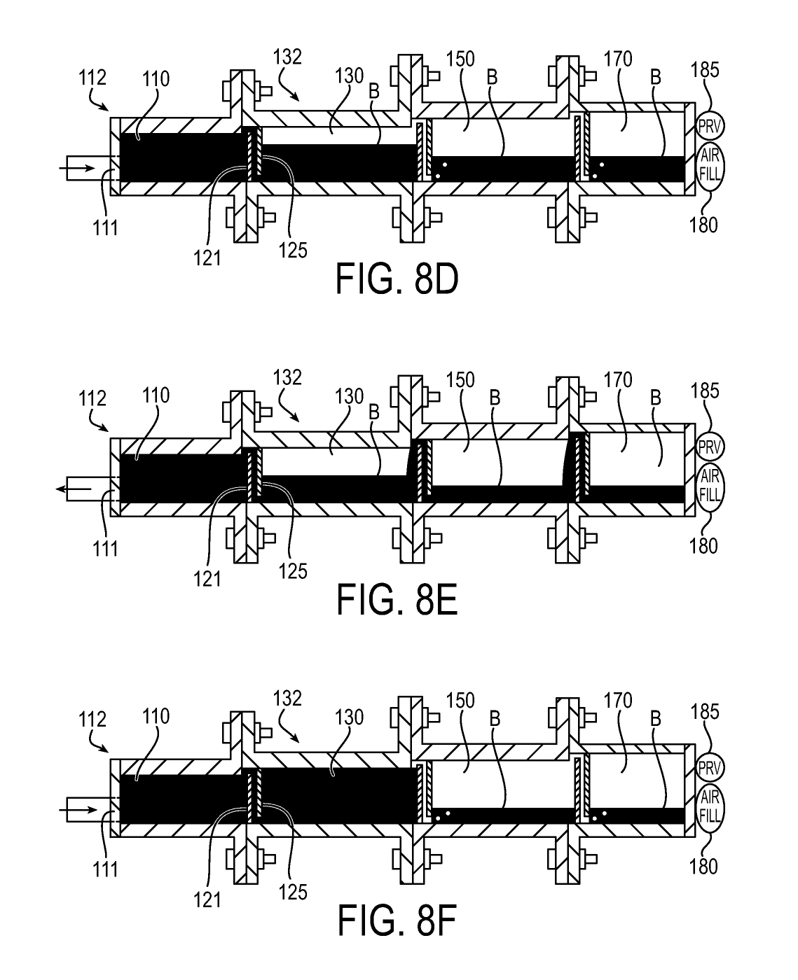

Yet another aspect of the present invention includes a method for degassing a hydraulic fluid for use in a hydraulic system, as depicted in FIGS. 8A-8F. The pressure vessel of FIGS. 8A-8F is the same as pressure vessel 100 of FIG. 1A, but also shows a gas port 180 and a pressure relief valve 185 connected thereto, and consequently the same reference numerals are used. FIG. 8A depicts a starting condition of hydraulic fluid in pressure vessel 100. In FIG. 8B, hydraulic fluid having trapped gases is allowed to enter non-barrier pressure vessel 100 through opening 111, whereby the hydraulic fluid having trapped gases is caused to enter first chamber 110, and begins to fill chamber 110. Still referring to FIG. 8B, as hydraulic fluid enters first chamber 110, the gas is caused to move through the space above the top edge 123 of bottom baffle 121, then through the baffle channel 128, and then through the space below the bottom edge 127 of top baffle 125, whereby the gases are caused to enter second chamber 130 and can escape the working fluid through a gas-fluid boundary (B). In response to gases being forced through upstream chambers, the gas located at the top of downstream chambers 130, 150 is forced through respective bottom and top baffles in a corresponding manner, causing the gas to accumulate in the last downstream chamber 170.

An exemplary method for discharging degassed hydraulic fluid from pressure vessel 100 is shown in FIG. 8C. According to this method, degassed hydraulic fluid is allowed to discharge from non-barrier pressure vessel 100 through opening 111, whereby the degassed hydraulic fluid is caused to exit first chamber 110. In response to differential pressure acting on the gas-fluid boundary (B), the degassed hydraulic fluid from second chamber 130 is caused to flow through the space below the bottom edge 127 of top baffle 125, then through the baffle gap 128, and then through the space above the top edge 123 of bottom baffle 121, whereby degassed hydraulic fluid is caused to enter first chamber 110 for replenishing the degassed hydraulic fluid that has exited first chamber 110. In this manner, degassed hydraulic fluid is drained from each downstream chamber 130, 150, 170 and flows into operatively adjoining upstream chambers.

In a certain preferred, but non-limiting method of the invention, first chamber 110 remains filled with hydraulic fluid and is devoid of a gas-fluid boundary as hydraulic fluid enters pressure vessel 100, as shown in FIG. 8D. In this manner, the method for degassing hydraulic fluid having trapped gases according to FIG. 8D is the same as described with respect to FIG. 8B, except that first chamber 110 is full of hydraulic fluid and gases entering first chamber 110 are thereby forced to downstream chambers through bottom and top baffles, as shown.

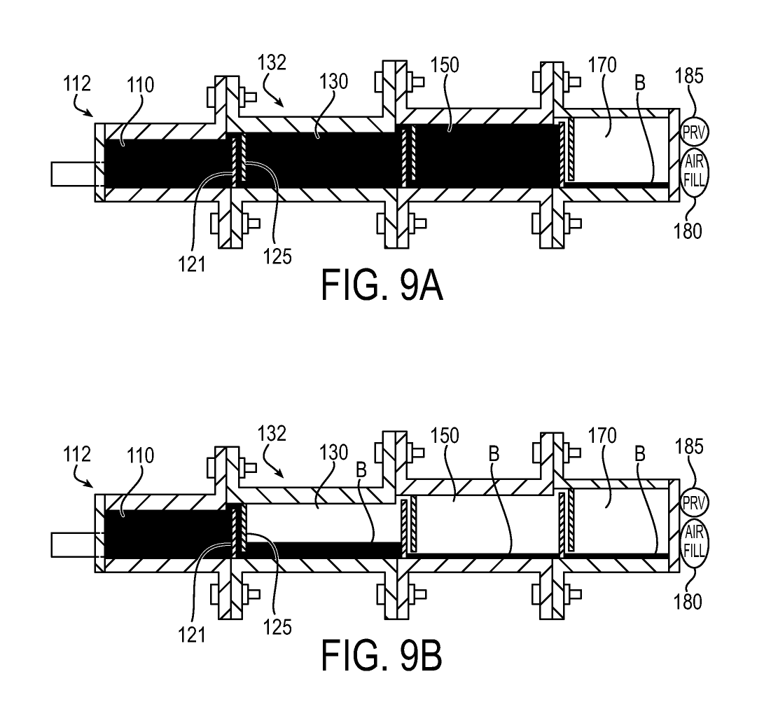

As described above, the cross-sectional area of the flow passage may be so dimensioned for reducing a “waterfall effect,” such that gas trapped in the uppermost area of the flow passage (e.g., the area above the top edge 123 of bottom baffle 121) is swept away by the hydraulic fluid flowing through the flow passage. In the discharging condition, depicted in FIG. 8E, first chamber 110 remains full as degassed hydraulic fluid flows from downstream chambers into first chamber 110, and then exits the pressure vessel through opening 111. As shown in FIG. 8F, hydraulic fluid can continue fill each subsequent downstream chamber until pressure vessel 100 reaches a preferred full state, which is depicted in FIG. 9A. The configuration and methods according to FIGS. 8D-8F provide an advantage of reducing the likelihood that the gas-fluid boundary will reach opening 111 and reenter the hydraulic system, even if pressure vessel 100 is in a preferred empty state, as depicted in FIG. 9B.

It should be understood that the pressure vessel may be made of any suitable material, such as metals, plastics and/or composites, which may be selected in a well-known manner to accommodate the pressures, flow rate, temperature, fluid types, imperviousness to liquids and gas, external environment, size, configuration, assembly, and other factors that would be obvious from the foregoing description.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A horizontal non-barrier pressure vessel comprising:
an opening for enabling flow of hydraulic fluid into or out of the pressure vessel;
a first chamber having a first end proximal said opening and a second end distal said opening, the first chamber having an uppermost surface that extends horizontally along the length of the first chamber or is inclined upwardly from the first end to the second end of the first chamber;
a second chamber operatively adjoining said first chamber at the second end of the first chamber opposite the opening;
a divider separating the first chamber from the second chamber; and
a flow passage across the divider for enabling hydraulic fluid to flow between an upper region of the first chamber to a lower region of the second chamber, the flow passage communicating with the upper region at the second end of the first chamber and the lower region of the second chamber.

2. The horizontal non-barrier pressure vessel according to claim 1, wherein said flow passage communicates with the second end of the first chamber at a level no less than the lowest level of the uppermost surface of the first chamber, and
wherein said flow passage has a cross-sectional area no greater than twice the cross-sectional area of said opening.

3. The horizontal non-barrier pressure vessel according to claim 1, wherein said divider comprises a bottom baffle and a top baffle;
wherein said bottom baffle is positioned proximal said first chamber, said bottom baffle extending upwardly from a bottom portion of the pressure vessel and terminating at a top edge that is spaced from a top interior surface of the pressure vessel and defines a top gap;
wherein said top baffle is positioned distal said first chamber, said top baffle extending downwardly from a top portion of the pressure vessel and terminating at a bottom edge that is spaced from a bottom interior surface of the pressure vessel and defines a bottom gap;
wherein the bottom edge of said top baffle is arranged at a level below the level of the top edge of said bottom baffle;
wherein said top baffle and said bottom baffle are spaced apart for forming a baffle channel therebetween; and
wherein said flow passage comprises said top gap, said bottom gap, and said baffle channel.

4. The horizontal non-barrier pressure vessel according to claim 3, wherein said first chamber comprises a top interior surface having a major portion and a minor portion, said minor portion being located proximal the top edge of said bottom baffle;
wherein said top interior surface minor portion is arranged at a level above said top interior surface major portion; and
wherein the top edge of said bottom baffle is arranged at the same level or at a level above the top interior surface major portion, said top edge of the bottom baffle being spaced from the respective top interior surface major and minor portions for enabling gas in the first chamber to escape into the second chamber in response to hydraulic fluid entering the first chamber.

5. The horizontal non-barrier pressure vessel according to claim 4, wherein the top interior surface minor portion is configured as an upward step.

6. The horizontal non-barrier pressure vessel according to claim 1, wherein said second chamber comprises an internal cross-sectional area at least as large as the internal cross-sectional area of said first chamber.

7. The horizontal non-barrier pressure vessel according to claim 1, wherein said first chamber and said second chamber are cylindrical.

8. The horizontal non-barrier pressure vessel according to claim 4, wherein the top interior surface of said first chamber is arranged as an upwardly inclined plane; and
wherein said first chamber and said second chamber are frustum shaped, said top interior surface minor portion being defined by the continuum of the inclined plane that defines said top interior surface major portion.

9. The horizontal non-barrier pressure vessel according to claim 1, wherein the sequential arrangement of said first chamber and said second chamber defines a pressure vessel course; and
wherein said pressure vessel includes a course selected from the group consisting of straight, curved, bent, s-shaped, and forked.

10. The horizontal non-barrier pressure vessel according to claim 1, wherein said pressure vessel comprises at least one additional chamber operatively adjoining said second chamber;
wherein said second chamber and said at least one additional chamber are separated by a second bottom baffle and a second top baffle;
wherein said second bottom baffle is positioned proximal said second chamber, said second bottom baffle extending upwardly from a bottom portion of the pressure vessel and terminating at a top edge that is spaced from a top interior surface of the pressure vessel;
wherein said second top baffle is positioned distal said second chamber, said second top baffle extending downwardly from a top portion of the pressure vessel and terminating at a bottom edge that is spaced from a bottom interior surface of the pressure vessel;
wherein the bottom edge of said second top baffle is arranged at a level below the level of the top edge of said second bottom baffle; and
wherein said second top baffle and said second bottom baffle are spaced apart for forming a second baffle channel therebetween.

11. The horizontal non-barrier pressure vessel according to claim 1, comprising a plurality of additional chambers, wherein said second chamber and/or at least one of said plurality of additional chambers is operatively connected to an external gas vessel.

12. A non-barrier pressure vessel comprising:
a top portion, a bottom portion, and opposing first and second end portions;
an opening for enabling flow of hydraulic fluid into or out of the pressure vessel, said opening being proximal said first end portion;
a plurality of segments sequentially arranged from said first end portion to said second end portion along a horizontal course, said plurality of segments comprising:
a first segment comprising the first end portion;
at least one additional segment, wherein said at least one additional segment comprises:
a portion of an upstream chamber;
a portion of a downstream chamber operatively adjoining said upstream chamber, said downstream chamber being positioned distal said first end portion;
a bottom baffle and a top baffle separating said upstream chamber from said downstream chamber;
wherein said bottom baffle is positioned proximal said upstream chamber, said bottom baffle extending upwardly from the bottom portion of the pressure vessel and terminating at a top edge that is spaced from a top interior surface of the pressure vessel;
wherein said top baffle is positioned distal said upstream chamber, said top baffle extending downwardly from the top portion of the pressure vessel and terminating at a bottom edge that is spaced from a bottom interior surface of the pressure vessel;
wherein the bottom edge of said top baffle is arranged at a level below the level of the top edge of said bottom baffle; and
wherein said top baffle and said bottom baffle are spaced apart for forming a baffle channel therebetween.

13. The non-barrier pressure vessel according to claim 12, wherein said respective plurality of segments are connected by at least one of a flange, a fastener, a thread, and a weld.

14. The non-barrier pressure vessel according to claim 12, wherein said respective plurality of segments each have an interior surface defining a chamber major portion;
wherein the internal cross-sectional areas of said respective chamber major portions are substantially the same size along the pressure vessel course.

15. The non-barrier pressure vessel according to claim 12, wherein said respective plurality of segments each have an interior surface defining a chamber major portion;
wherein the internal cross-sectional areas of said respective chamber major portions are progressively larger along the pressure vessel course.

16. The non-barrier pressure vessel according to claim 12, wherein the pressure vessel further comprises:
an external gas vessel operatively connected to the pressure vessel distal said first end portion; and
a pressure relief valve for releasing pressurized gas, said pressure relief valve being operatively connected to the pressure vessel distal said first end portion.

17. The non-barrier pressure vessel according to claim 12, wherein said pressure vessel course is selected from the group consisting of straight, curved, bent, s-shaped, and forked.

18. A method for degassing a hydraulic fluid for use in a hydraulic system, the method comprising the steps:
allowing hydraulic fluid having trapped gases to enter a non-barrier pressure vessel according to claim 1 through the opening;
causing the hydraulic fluid having trapped gases to enter the first chamber;
causing the trapped gases to move through the space above the top edge of the bottom baffle, then through the baffle channel, and then through the space below the bottom edge of the top baffle;
causing the hydraulic fluid having trapped gases to enter the second chamber; and
causing the trapped gases to escape the working fluid through a gas-fluid boundary located in a chamber downstream from said first chamber.

19. The method of claim 18 further comprising the steps:
allowing degassed hydraulic fluid to discharge from the non-barrier pressure vessel through the opening;
causing the degassed hydraulic fluid to exit the first chamber;
causing degassed hydraulic fluid from the second chamber to flow through the space below the bottom edge of the top baffle, then through the baffle gap, and then through the space above the top edge of the bottom baffle; and
causing degassed hydraulic fluid to enter the first chamber for replenishing the degassed hydraulic fluid that has exited the first chamber.

20. The method of claim 18, wherein the first chamber is full of hydraulic fluid and devoid of a gas-fluid boundary prior to at least one of the steps of:
causing hydraulic fluid having trapped gases to enter the first chamber; and
causing degassed hydraulic fluid to exit the first chamber.
